(19) United States
(12) Patent Application Publication
(10) Pub. No.: US 2017/0261750 A1
(43) Pub. Date: Sep. 14, 2017

(54) Co-Aligned Retinal Imaging And Display System

(71) Applicant: Google Inc., Mountain View, CA (US)

(72) Inventors: Adrian Wong, Mountain View, CA (US); Philipp Helmut Schmaelzle, Los Altos, CA (US); Samuel D'Amico, Menlo Park, CA (US)

(73) Assignee: Google Inc., Mountain View, CA (US)

(21) Appl. No.: 14/283,069

(22) Filed: May 20, 2014

Related U.S. Application Data
(60) Provisional application No. 61/911,793, filed on Dec. 4, 2013.

(51) Int. Cl. G02B 27/01

(52) U.S. Cl. CPC G02B 27/0172; G02B 27/0101; G02B 2027/0138; G02B 2027/0178

(57) ABSTRACT

Apparatus are described herein including an imaging device and a multi-pixel display disposed in a head-mountable device (HMD). The apparatus includes an optical system configured to optically couple the multi-pixel display and the imaging device to a retina of a wearer of the head-mountable device, such that the retina is at a focal plane that is conjugate to both a first focal plane at the multi-pixel display and a second focal plane at the imaging device. The direction of gaze of a user of the HMD could be determined from the retinal image. The determined gaze direction could be used to operate the HMD. The pattern of vasculature in the retinal image could be used to identify the user of the HMD. Information in the retinal image could be used to determine the medical state of the user and diagnose disease states.

### CROSS-REFERENCE TO RELATED APPLICATIONS

This application claims priority to U.S. Provisional Application No. 61/911,793, filed Dec. 4, 2013, the contents of which are incorporated herein by reference.

### BACKGROUND

Unless otherwise indicated herein, the materials described in this section are not prior art to the claims in this application and are not admitted to be prior art by inclusion in this section.

Wearable systems can integrate various elements, such as miniaturized computers, input devices, sensors, detectors, image displays, wireless communication devices as well as image and audio processors, into a device that can be worn by a user. Such devices provide a mobile and lightweight solution to communicating, computing and interacting with one's environment. With the advance of technologies associated with wearable systems and miniaturized optical elements, it has become possible to consider wearable compact optical displays that augment the wearer's experience of the real world.

By placing an image display element close to the wearer's eye(s), an artificial image can be made to overlay the wearer's view of the real world. Such image display elements are incorporated into systems also referred to as “near-eye displays”, “head-mounted displays” or “heads-up displays” (HUDs). Depending upon the size of the display element and the distance to the wearer's eye, the artificial image may fill or nearly fill the wearer's field of view.

### SUMMARY

Some embodiments of the present disclosure provide a device that includes: a head-mountable support; a multi-pixel display supported by the head-mountable support, in which the multi-pixel display is configured to generate a light pattern; an imagining device supported by the head-mountable support; and an optical system supported by the head-mountable support, in which the optical system is configured to optically couple the multi-pixel display and the imaging device to a retina in an eye such that the retina is at a focal plane that is conjugate to both a first focal plane at the multi-pixel display and a second focal plane at the imaging device.

Some embodiments of the present disclosure provide a method that includes: projecting, from a head-mountable device (HMD), patterned light in-focus onto a retina of an eye, where the patterned light is produced by a multi-pixel display disposed in the HMD; and imaging the retina using an imager disposed in the HMD, where the retina is at a focal plane that is conjugate to both a first focal plane at the multi-pixel display and a second focal plane at the imager.

### BRIEF DESCRIPTION OF THE DRAWINGS

FIG. 1 illustrates a head-mountable device optically coupled to an eye according to an example embodiment.

FIG. 2 illustrates a head-mountable device according to an example embodiment.

FIG. 3A illustrates a head-mountable device according to an example embodiment.

FIGS. 3B to 3D are simplified illustrations of the head-mountable device shown in FIG. 3A, being worn by a wearer.

FIG. 4 is a functional block diagram of a head-mountable device according to an example embodiment.

FIG. 5 is a flow chart of a method, according to an example embodiment.

### DETAILED DESCRIPTION

### I. Overview

Disclosed herein are methods and systems for retinal imaging and display. In some examples, a head-mountable device (HMD) can include retinal imaging and display functionality. In this way, when the HMD is worn by a wearer, the HMD can image the retina of one or both of the wearer's eyes. The HMD can additionally project a light pattern from a multi-pixel display onto the retina of one or both of the wearer's eyes. The retinal imaging and multi-pixel display by the HMD could occur automatically, or could occur in response to an instruction from the wearer.

Including a retinal imaging system in an HMD could provide a number of useful functions to the HMD. The direction of gaze of a user of the HMD could be determined from the retinal image. This gaze direction information could be used to determine what the user was looking at, and this information could be used to alter the function of the HMD. The identity of the user of the HMD could be determined from the pattern of vasculature in the retinal image. This determination of identity could be used to alter the function of the HMD according to a personal configuration associated with the identified user. This identification could also be used as a form of biometric security, unlocking functions of the device for specific users or acting to identify the user to remote services accessed by the HMD. Information in the retinal image could also be used to determine the medical state of the user and diagnose disease states. For example, analysis of the vasculature of the retina could indicate that diabetic retinopathy was occurring; detection of this condition at an early stage could beneficially facilitate preventive treatment.

In one example, the HMD includes a multi-pixel display system that projects patterned light in-focus onto the retina of the user. In such systems, the user may be able to adjust the positioning of the HMD being worn by the user and/or adjust the user's gaze direction so that the projected patterned light is in-focus and correctly aligned with the pupil and retina of the eye of the user.

The HMD could further include a retinal imaging system. The retinal imaging system could be operationally coupled to optical elements of the multi-pixel display system such that a light sensing element of the imaging system was disposed at a focal plane conjugate to a focal plane at the retina of the wearer. Further, a light-patterning element of the multi-pixel display system could be located on another focal plane conjugate to the focal plane at the retina of the wearer. In this way, user actions to position the HMD such that patterned light from the multi-pixel display system is aligned and in-focus on the user's retina would also act to position the HMD such that light from the retina is aligned and in-focus on the light sensing element of the imaging system.

An HMD configured to acquire images of the retina could also be configured to illuminate the retina. Illumination can be provided through the same optical system to which the imaging system is operatively coupled. For example, the illumination could be provided by the same components used to generate light for the multi-pixel display system or could be generated by some other component. Alternatively or additionally, illumination could be provided from components of the HMD which are not operatively coupled with the optical elements of the display system. As one example, an LED could be mounted on the HMD so as to emit light toward the eye of the user. As another example, near-infrared illumination of the retina can be provided through the temple of the user, allowing an illumination source to be mounted on the HMD over the temple of the user. Alternatively, the retina can be imaged using ambient illumination.

### II. Example Head-Mountable Devices

Systems and devices in which example embodiments can be implemented will now be described in greater detail. In general, an example system can be implemented in or can take the form of a head-mountable device (HMD). An HMD can generally be any device that is capable of being worn on the head and places an imaging device in front of one or both eyes of the wearer. An HMD can take various forms such as a helmet or eyeglasses. As such, references to “eyeglasses” or a “glasses-style” HMD should be understood to refer to an HMD that has a glasses-like frame so that it can be worn on the head. Further, example embodiments can be implemented by or in association with an HMD operating to image one or both eyes, which can be referred to as a “monocular” HMD or a “binocular” HMD, respectively.

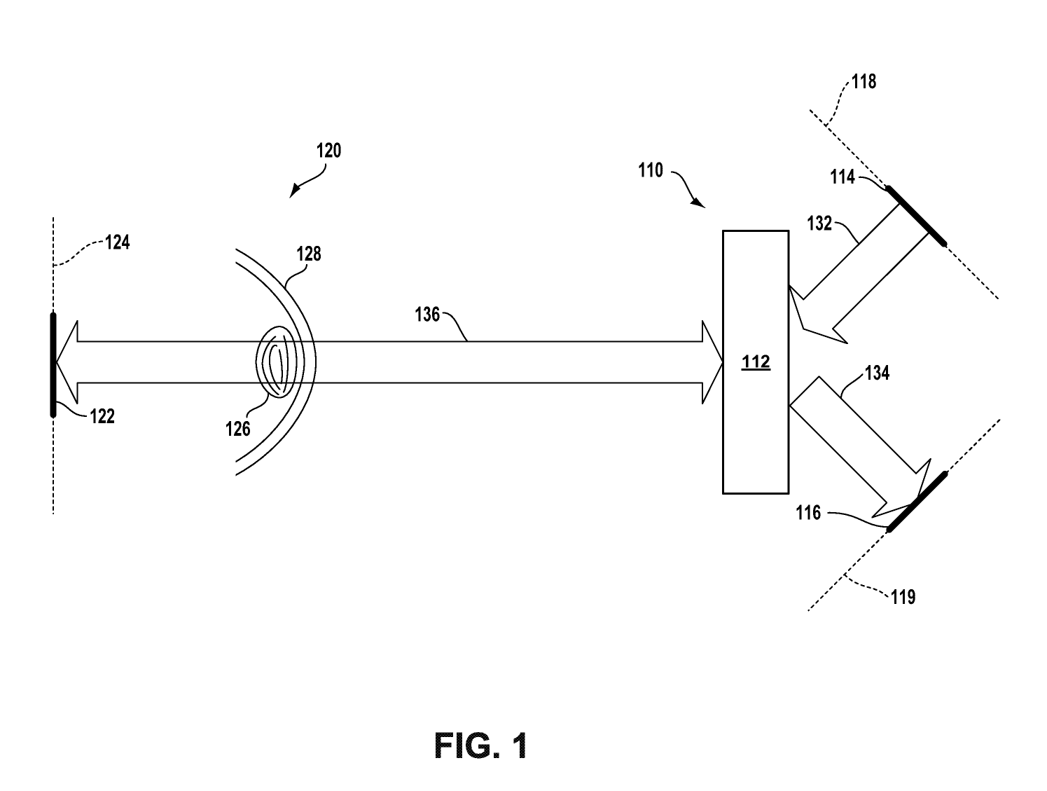

FIG. 1 schematically illustrates an HMD 110 that is optically coupled to an eye 120. The HMD 110 includes an optical system 112, a multi-pixel display 114, and an imager 116. The optical system 112 is optically coupled to the multi-pixel display 114 and the imager 116. The multi-pixel display 114 is configured to produce a pattern of light according to an application. The imager 116 is configured to produce images of light to which the imager is exposed. The HMD 110 additionally includes a head-mountable support (not shown). The head-mountable support can be configured to allow for stable mounting of the HMD 110 on a head of a wearer so that the HMD 110 is optically coupled to the eye 120 of the wearer of the HMD 110. The eye 120 includes a retina 122 substantially located on a focal plane of the retina 124. The eye 120 additionally includes a crystalline lens 126 and a cornea 128.

The HMD 110 may be able to generate a multi-pixel virtual image that is viewable, by the wearer using eye 120, when the eye 120 is substantially aligned with the HMD 110 as shown in FIG. 1. The HMD 110 could also allow light emitted or reflected by the retina 122 to be imaged by the imager 116 when the eye 120 substantially aligned with the HMD 110.

The optical system 112 could be configured to enable the functions of the HMD 110 (e.g., generation of a multi-pixel virtual image that is viewable by the wearer and imaging the retina 122 of the wearer). The optical system 112 can focus light from the multi-pixel display 114 onto the retina 124, via the optical elements in the wearer's eye 120 (including the crystalline lens 126 and the cornea 128) and can also focus light reflected by the retina 124 through the optical elements in the wearer's eye 120 (including the crystalline lens 126 and the cornea 128) onto the imager 116. That is, the optical system 112 can be configured to optically couple the multi-pixel display 114 and the imager 116 to the retina 122 in the wearer's eye 120 such that the retina 122 is at a focal plane of the retina 124 that is conjugate to both a focal plane 118 at the multi-pixel display 114 and a focal plane 119 at the imager 116. As a result, when the wearer has adjusted the HMD 110 such that the multi-pixel virtual image viewed by the wearer's eye 120 appears to be in focus, light reflected by the retina 122 in the wearer's eye 120 is in focus on the imager 116.

To illustrate this arrangement, FIG. 1 includes a display optical path 132, an imager optical path 134, and a common optical path 136. It is to be understood that paths 132, 134, and 136 are not intended to illustrate actual paths of light rays but, rather, to schematically illustrate the passage of light from one element to another. The display optical path 132 and common optical path 136 schematically illustrate the passage of light from the multi-pixel display 114 to the optical system 112, and from the optical system 112 to the retina 122 through the eye 120, including passage through the cornea 128 and crystalline lens 126. Because the focal planes 118 and 124 are conjugate to one another, the light from the display 114 forms a real image on the retina 122. The imager optical path 134 and common optical path 136 schematically illustrate the passage of light from the retina 122 through the eye 120 (including passage through the crystalline lens 126 and cornea 128), to the optical system 112, and from the optical system 112 to imager 116. Because the focal planes 119 and 124 are conjugate to one another, the light from the retina 122 forms a real image on the imager 116.

The optical system 112 could be any arrangement of one or more optical components (such as lenses, mirrors, beam splitters, etc.) that can optically couple the multi-pixel display 114 and the imager 116 to the retina 122, such that the focal plane 124 at the retina 122 is conjugate to both the focal plane 118 at the imager 116 and the focal plane 119 at the multi-pixel display 114. With this arrangement, a plurality of points on the retina 122 can be imaged in-focus at the imager 116. This same plurality of points on the retina 122 can also receive the light from the multi-pixel display 114 when the optical system 112 is used to produce a multi-pixel virtual image that is focused onto the retina 122 by the optical elements within the wearer's eye 120 (including the crystalline lens 126 and the cornea 128).

For purposes of illustration, focal plane 118 at the multi-pixel display 114 and focal plane 119 at the imager are shown as being perpendicular to one another. It is to be understood, however, that other arrangements are possible as well. In general, focal planes 118 and 119 could be either parallel (e.g., co-planar) or non-parallel (e.g., perpendicular).

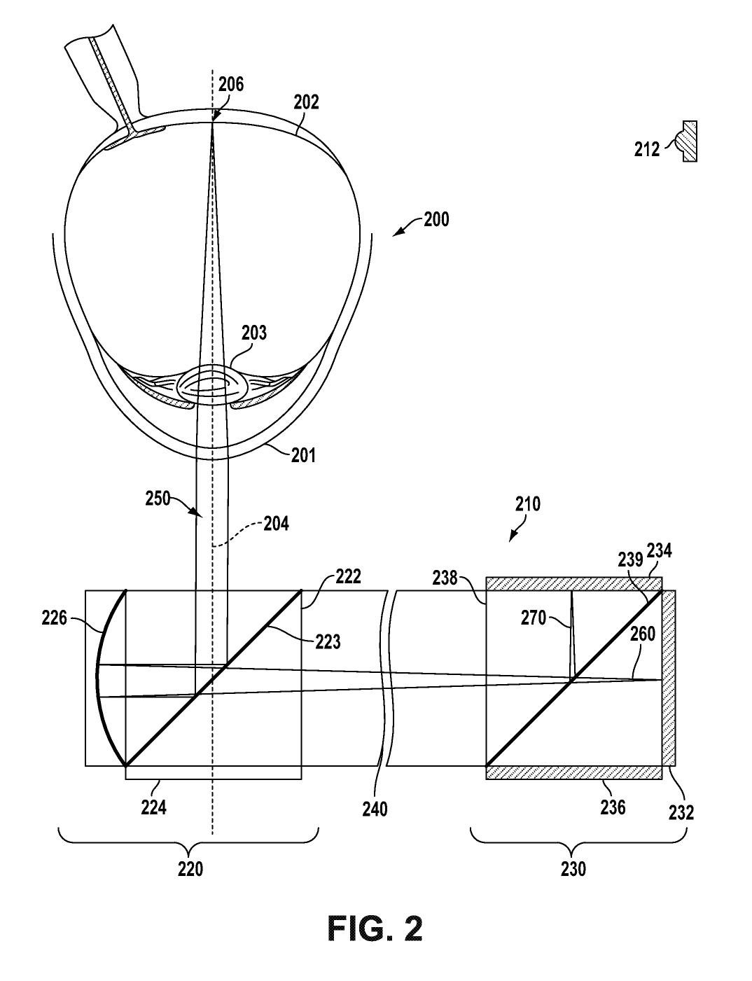

FIG. 2 illustrates a cross-sectional view of elements of a monocular HMD according to an example embodiment. The HMD includes an optical system 210 and a light source 212 that are supported by a head-mountable support (not shown). The head-mountable support can be configured to allow for stable mounting of the HMD on a head of a wearer. The head-mountable support can configured to support the HMD on one or more of an ear, a nose, or another aspect of the head of the wearer. Also shown in FIG. 2 is an eye 200 of the wearer, as well as a cornea 201, retina 202, and crystalline lens 203 in the eye 200. The cross-sectional view of FIG. 2 is taken horizontally through the eye 200 of the wearer and through the optical system 210 and the light source 212 of the HMD worn by the wearer. That is, movement out of the page of FIG. 2 corresponds to upward vertical movement relative to the wearer (toward the top of the head of the wearer) and movement into the page of FIG. 2 corresponds to downward vertical movement relative to the wearer (toward a foot of the wearer).

In this example, the structure of the eye 200 and the retina 202 define a gaze direction 204 that represents the direction the wearer is looking. The retina 202 includes an example point on the retina 206 that is located at the intersection of the gaze direction 204 and the retina 202. The location and scale of the optical system 210 of the HMD as shown in FIG. 2 in relation to the eye 200 and the gaze direction 204 are not meant to be limiting, but to act as an illustration of the components and operation of an example embodiment.

The light source 212 can be configured to produce light of a near-infrared wavelength able to be transmitted through a temple of the wearer. The light source 212 can be located in the HMD such that when a user wears the HMD the light source 212 is able to illuminate the retina 202 through the temple of the wearer. The light source 212 can be configured to produce light of a wavelength between 700 nm and 900 nm. The light source 212 can be configured to produce light of other wavelengths than near-infrared wavelengths according to an application. The light source 212 can be located as illustrated in FIG. 2 or located at another location on the HMD such that the light source 212 is able to illuminate the retina 202. The light source 212 and optical system 210 can be configured such that the light source 212 projects light into the optical system 210 and the optical system 210 projects the light produced by the light source 212 toward the eye 200 such that the retina 202 is illuminated.

For purposes of illustration, the optical system 210 can be described in terms of a proximal portion 220 and a distal portion 230. In typical operation, the proximal portion 220 is proximal to the eye 200 of the wearer, whereas the distal portion 230 is located some distance away from the eye 200 of the wearer. In the example illustrated in FIG. 2, the optical system 210 extends horizontally such that distal portion 230 is to the left of the proximal portion 220 from the perspective of the wearer. It is to be understood, however, that other configurations are possible. For example, the distal portion 230 could be to the right of the proximal portion 220, or optical system 210 could extend vertically, with distal portion 230 located above or below proximal portion 220. Other configurations are also possible.

The optical system 210 may be able to generate a multi-pixel virtual image that is viewable, by the wearer using eye 200, when the gaze direction 204 is substantially aligned with the proximal portion 220 as shown in FIG. 2. The wearer may also be able to view the wearer's real-world environment along the gaze direction 204. In an example embodiment, the real-world environment and the multi-pixel virtual image are viewable simultaneously. For example, the multi-pixel virtual image might overlay a portion of the observer's view of the real-world environment. The multi-pixel virtual image could appear to the wearer to be located at or near infinity. Alternatively, the multi-pixel virtual image could appear to be located within the immediate surroundings of the wearer. For example, the apparent distance of the multi-pixel virtual image could be in the range of about 0.5 to 4 meters.

In an example embodiment, the gaze direction 204 passes through a proximal beam splitter 222. The eye 200 of the wearer may be located on one side of proximal beam splitter 222, and the other side of the proximal beam splitter 222 may be provided with a viewing window 224 that allows light into the proximal beam splitter 222 from outside of the optical system 210. In this way, the wearer is able to view the real world through the viewing window 224 and the proximal beam splitter 222, along the gaze direction 204.

The proximal beam splitter 222 includes a proximal beam-splitting interface 223 that is configured to combine light entering the proximal beam splitter 222 through the viewing window 224 with light from the multi-pixel virtual image generated by the optical system 210, so that both the real-world environment and the multi-pixel virtual image can be viewed along the gaze direction 204. For example, the proximal beam-splitting interface 223 may be in a plane that intersects the gaze direction 204 at an angle, such as a 45-degree angle.

In an example embodiment, the proximal beam-splitting interface 223 is configured to transmit the light entering through the viewing window 224 so that it is viewable along the gazedirection 204 and to reflect the light corresponding to the multi-pixel virtual image so that it is also viewable along the gaze direction 204. Further, the proximal beam-splitting interface 223 can be configured to reflect light emitted or reflected from the retina 202 so that the retina 202 can be imaged by the optical system 210. In this regard, the proximal beam splitter 223 may be optically coupled to an image former 226, which may be located in the proximal portion 220 as shown in FIG. 2. The image former 226 may include a concave mirror that reflects light corresponding to the multi-pixel virtual image and light corresponding to the image of the retina 202. Thus, the light from outside entering through the viewing window 224 may propagate along the gaze direction 204 so that it is transmitted through the beam-splitting interface 223 toward the retina 202 of the wearer, and the light corresponding to the multi-pixel virtual image may propagate in the left direction from the image former 216 until it is reflected towards the retina 202 by the beam-splitting interface 223. Further, the light reflected from the retina 202 may propagate from the retina 202 until it is reflected toward the image former 226 by the beam splitting interface 223.

In the example illustrated in FIG. 2, the proximal beam splitter 222 is a 45-degree beam splitter. Thus, the proximal beam-splitting interface 223 is in a plane that forms 45-degree angles with the faces of the beam splitter 222. As a result, the proximal beam-splitting interface 223 intersects the example gaze direction 204 at 45 degrees. It is to be understood, however, that other angles are possible.

In an example embodiment, the proximal beam splitter 222 is a 50/50 beam splitter, in which the beam-splitting interface 223 reflects half of any incident light and transmits the other half of the incident light. In order to prevent stray light in the optical system 210 from interfering with imaging the retina 202, the viewing window 224 may include a light filter that selectively blocks light of wavelengths corresponding to the wavelength of the light produced by the light source 212 and reflected by the retina 202.

The optical system 210 includes an imager 232 that is configured to image the retina 202 using light reflected by the retina 202 in response to illumination of the retina 202 by light produced by the light source 212. The imager 232 can include a photodetector array that is sensitive to light of a wavelength corresponding to the wavelength of the light produced by the light source 212. For example, the imager 232 could include an array of CMOS active pixel elements. In another example, the imager 232 could include a CCD image sensor array. The imager 232 could also include a light filter that selectively blocks light of wavelengths other than the wavelength of the light produced by the light source 212 and reflected by the retina 202 from being imaged by the imager 232. The imager 232 may be configured to capture still images and/or video.

The optical system 210 can include a multi-pixel display panel 234 that is configured to generate a light pattern from which the multi-pixel virtual image is formed. The multi-pixel display panel 234 may be an emissive display such as an Organic Light Emitting Diode (OLED) display. Alternatively, the multi-pixel display panel 234 may be a light modulator, such as a liquid-crystal on silicon (LCoS) array or a micro-mirror display such as a digital light processor (DLP), so as to generate the light pattern by spatially modulating light from a display light source 236. The display light source 236 may include, for example, one or more light-emitting diodes (LEDs) and/or laser diodes. The light pattern generated by the multi-pixel display panel 234 could be monochromatic, or it could include multiple colors (such as red, green, and blue) to provide a color gamut for the multi-pixel virtual image.

As shown in FIG. 2, the imager 232, the multi-pixel display panel 234, and the display light source 236 may be located in the distal portion 230 and optically coupled to a distal beam splitter 238. The distal beam splitter 238 may be, in turn, optically coupled to the proximal beam splitter 222, for example, via a light pipe 240. In an example embodiment, the distal beam splitter 238 includes a distal beam-splitting interface 239.

In the example shown in FIG. 2, the distal beam-splitting interface 239 is in a plane parallel to the plane of the proximal beam-splitting interface 223. It is to be understood that the configuration of the proximal beam splitter interface 223 and the distal beam splitter interface 239 to be in parallel planes is exemplary only; the beam splitter interfaces 223, 239 could occupy perpendicular planes or planes with any other relationship. Further, the 45-degree angle formed by the distal beam-splitting interface 239 is exemplary only. Other angles could be used.

With the multi-pixel display panel 234 located on the face of the distal beam splitter 238 toward the wearer, the display light source 236 may be located on the opposite face of the distal beam splitter 238. With this configuration, light from the display light source 236 could reach the multi-pixel display panel 234 through the distal beam splitter 238. In particular, the distal beam-splitting interface 239 could transmit at least a portion of the light from the display light source 236 so that it could reach the multi-pixel display panel 234. Additionally, the distal beam-splitting interface 239 could reflect at least a portion of the light from the display light source 236 to the imager 232. The multi-pixel display panel 234 could spatially modulate the incident light, and the distal beam-splitting interface 239 could reflect at least a portion of the spatially-modulated light from the multi-pixel display panel 234 toward the proximal beam splitter 222. The proximal beam-splitting interface 223 could transmit at least a portion of the spatially-modulated light so that it reaches the image former 226. The image former 226 could then form a multi-pixel virtual image from the spatially-modulated light, and the proximal beam-splitting interface 223 could reflect at least a portion of the spatially modulated light from the image former 226 so that the multi-pixel virtual image is viewable along the gaze direction 204.

This configuration could also allow light emitted or reflected by the retina 202 to be imaged by the imager 232. In particular, light reflected from the retina 202 could propagate toward the proximal beam splitter 222 along the gaze direction 204. The proximal beam-splitting interface 223 could reflect at least a portion of the incident image light toward the image former 226. The image former 226 could then reflect the image light toward the imager 232. The image light could be at least partially transmitted by each of the proximal beam-splitting interface 223 and the distal beam-splitting interface 239 on its way from the image former 226 to the imager 232.

In an example embodiment, the distal beam splitter 238 is a polarizing beam splitter, in which the distal beam-splitting interface 239 preferentially reflects s-polarized light and preferentially transmits p-polarized light. In that case, the display light source 236 may include a linear polarizer that selectively transmits p-polarized light. The p-polarized light from the display light source 236 is preferentially transmitted by the distal beam-splitting interface 239 so that it is incident on the display panel 234. In this example, the display panel 234 is a liquid crystal on silicon (LCOS) display panel. As such, the display panel 234 spatially modulates the incident p-polarized light and also changes its polarization. Thus, in this example, the display panel 234 converts the incident p-polarized light into a spatially-modulated light pattern of s-polarized light. The distal beam-splitting interface 239 reflects the s-polarized spatially-modulated light from the display panel 234 toward the proximal portion 220. The proximal portion 220 can then modify the s-polarized spatially-modulated light as described above so that a multi-pixel virtual image is viewable along the gazedirection 204.

An HMD could use the display light source 236 to illuminate the retina 202. For example, during a first time period, the display light source 236 could illuminate the display panel 234 and the display panel 234 could spatially modulate the incident light from the display light source 236 to produce a multi-pixel virtual image from which the cornea 201 and crystalline lens 203 in the eye 200 form a real image on the retina 202. During a second time period, the display light source 236 could illuminate the display panel 234 and the display panel 234 could spatially modulate the incident light from the display light source 236 such that an area of the retina 202 is uniformly illuminated. The retina 202 could reflect some of the incident light from the display light source 236, and the imager 232 could image the retina 202 using the light reflected during the second time period. In another example, the display panel 234 could spatially modulate the incident light from the display light source 236 during a plurality of time periods such that a different specified subsection of the retina 202 was illuminated during each of the time periods in the plurality of time periods, such that the image sensor could build a complete image of the retina 202 using light detected during each of the time periods in the plurality of time periods. The imager 232 could include a polarizing light filter to block the s-polarized light emitted by the display light source 236 and reflected by the distal beam-splitting interface 239 toward the imager 232.

Although an example is described above in which the proximal beam splitter 222 is a 50/50 beam splitter and the distal beam splitter 238 is a polarizing beam splitter, it is to be understood that the proximal beam splitter 222 and/or the distal beam splitter 238 could be differently configured. For example, one or both of the beam splitters 222, 238 could be a non-polarizing 80-20 beam splitter, in which the beam-splitting interface 223, 239 could transmit 80% of the incident light and reflect 20% of the incident light independent (or largely independent) of polarization. In the case where the proximal beam splitter 222 is configured this way, about 80% of the light entering through the viewing window 224 may reach the retina 202 of the wearer through the proximal beam-splitting interface 223 (instead of only about 50% when proximal beam splitter 222 is a 50/50 beam splitter). On the other hand, the proximal beam-splitting interface 223 would reflect only about 20% of the light from the image former 226 to the retina 202 or from the retina 202 to the imager 232. To compensate for the reduced reflectivity, the brightness of the light source 212 and/or the display light source 236 could be increased.

In an example embodiment, the proximal beam splitter 222, the distal beam splitter 238 and the light pipe 240 are made of glass. However, in order to reduce the weight of the optical system 210, some or all of these elements could be made of plastic instead of glass. A suitable plastic material is Zeonex® E48R cyclo olefin optical grade polymer, which is available from Zeon Chemicals L.P., Louisville, Ky. Another suitable plastic material is polymethyl methacrylate (PMMA).

With the configuration of optical system 210 described above, image former 226 can focus light from the multi-pixel display panel 234 onto the retina 202, via the optical elements in the wearer's eye 200 (including cornea 201 and crystalline lens 203) and can also focus light reflected by the retina 202 through the optical elements in the wearer's eye 200 (including cornea 201 and crystalline lens 203) onto the imager 232. That is, the optical system 210 can be configured to optically couple the multi-pixel display panel 234 and the imager 232 to the retina 202 in the wearer's eye 200 such that the retina 202 is at a focal surface that is conjugate to both a focal surface at the multi-pixel display panel 234 and another focal surface at the imager 232. As a result, when the wearer has adjusted the optical system 210 such that the multi-pixel virtual image viewed by the wearer's eye 200 appears to be in focus, light reflected by the retina 202 in the wearer's eye 202 is in focus on the imager 232.

To illustrate this arrangement, FIG. 2 includes an example common optical path 250. The common optical path 250, along with an example image sensor optical path 260, illustrates the path of light reflected by the example point on the retina 206 as it travels through the eye 200, to the optical system 210, and through the optical system 210 to be detected at a point on the imager 232. Conversely, example common optical path 250, along with an example display optical path 270, illustrates the path of light emitted from a point on the multi-pixel display panel 234 as it travels through the optical system 210, to the eye 200, and through the eye 200 to the example point on the retina 206.

The example image sensor optical path 260 and the example display optical path 270 are mirror images of each other about the plane of the distal beam-splitting interface 239. As a result, if the wearer adjusts one or more of the direction of gaze of the eye 200, the focus of the eye 202, and the location of the optical system 210 relative to the eye 200 such that multi-pixel virtual image light produced by the multi-pixel display panel 234 is in-focus at the example point on the retina 206, then light reflected by the example point on the retina 206 can be imaged in-focus at the imager 232.

It should be noted that the gaze direction 204, the point on the retina 206, the common optical path 250, the image sensor optical path 260, and the display optical path 270 are only illustrative examples used to describe the optical system 210 being configured to optically couple the display panel 234 and the imager 232 to the retina 202 of the wearer such that the retina 202 is at a focal surface that is conjugate to both a focal surface at the multi-pixel display panel 234 and another focal surface at the imager 232. Image former 226 can be configured so that a plurality of points on the retina 202 (including the example point on the retina 206) can be imaged in-focus at the imager 232. This same portion of the retina 202 can also receive the light from the multi-pixel display panel 234 when the image former 226 is used to produce a multi-pixel virtual image that is focused onto the retina 202 by the optical elements within the wearer's eye 200 (including the cornea 201 and crystalline lens 203).

Further, optical system 210 is only one example of an optical system which could be configured to optically couple a multi-pixel display and an imager to a retina of a wearer such that the retina is at a focal surface that is conjugate to both a focal surface at the multi-pixel display and another focal surface at the imager.

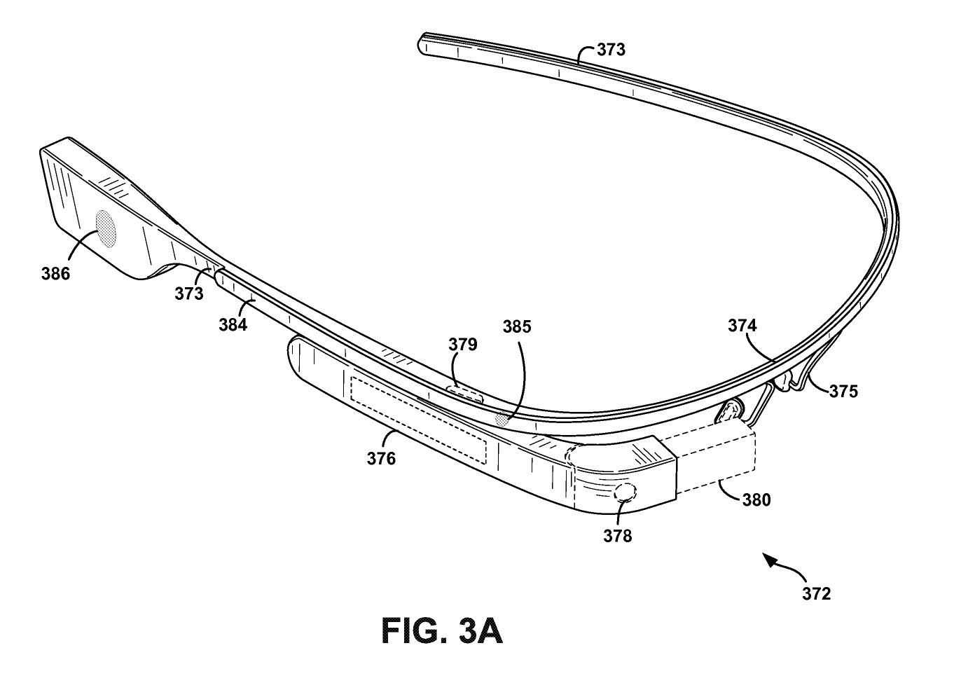

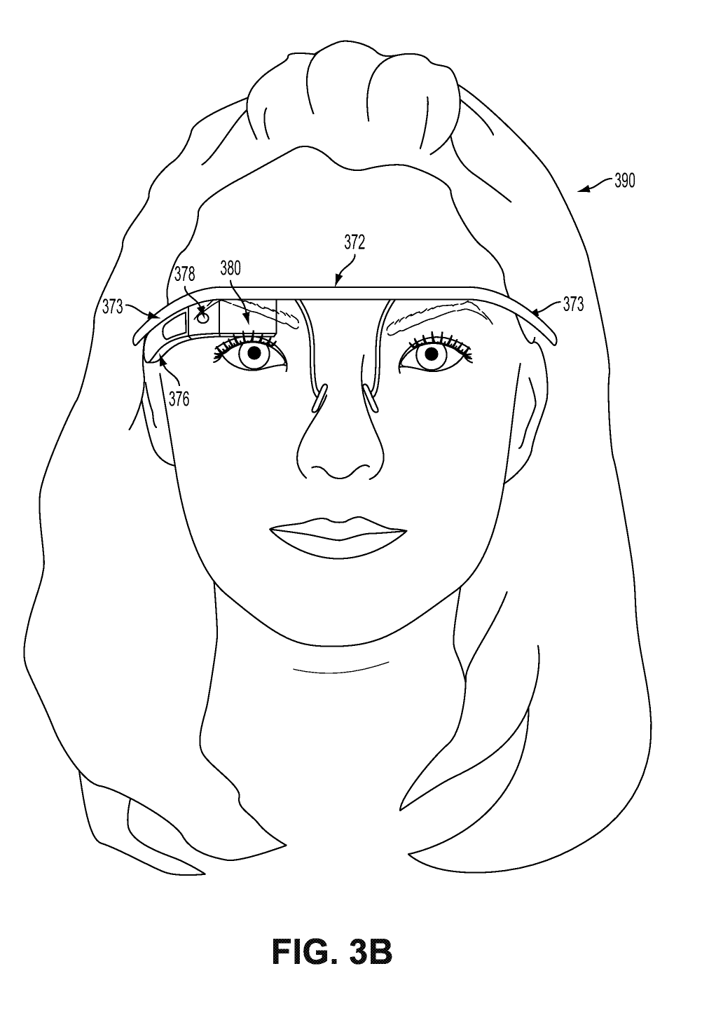

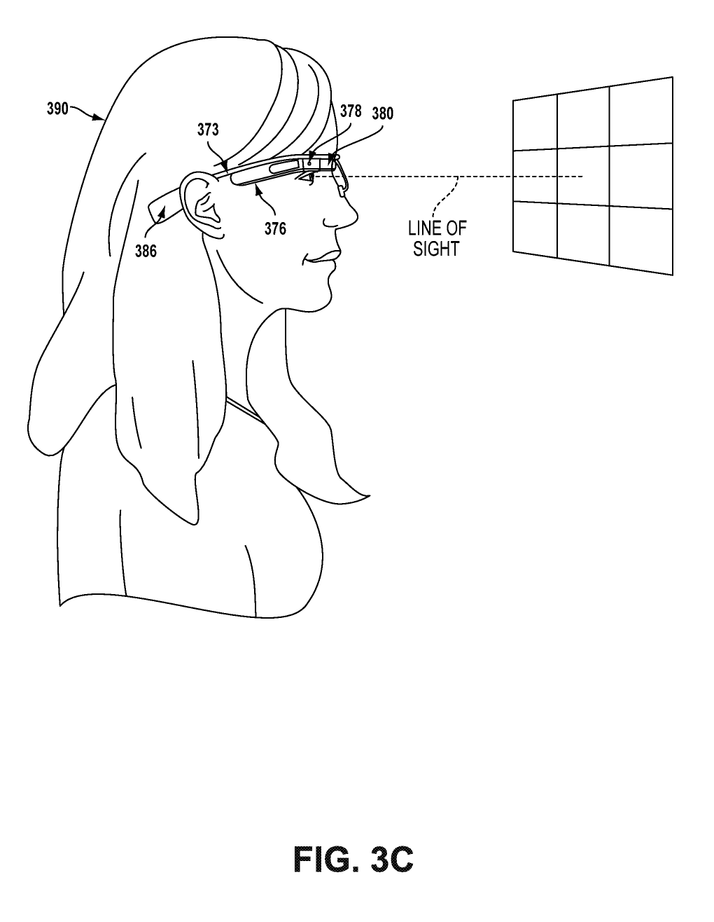

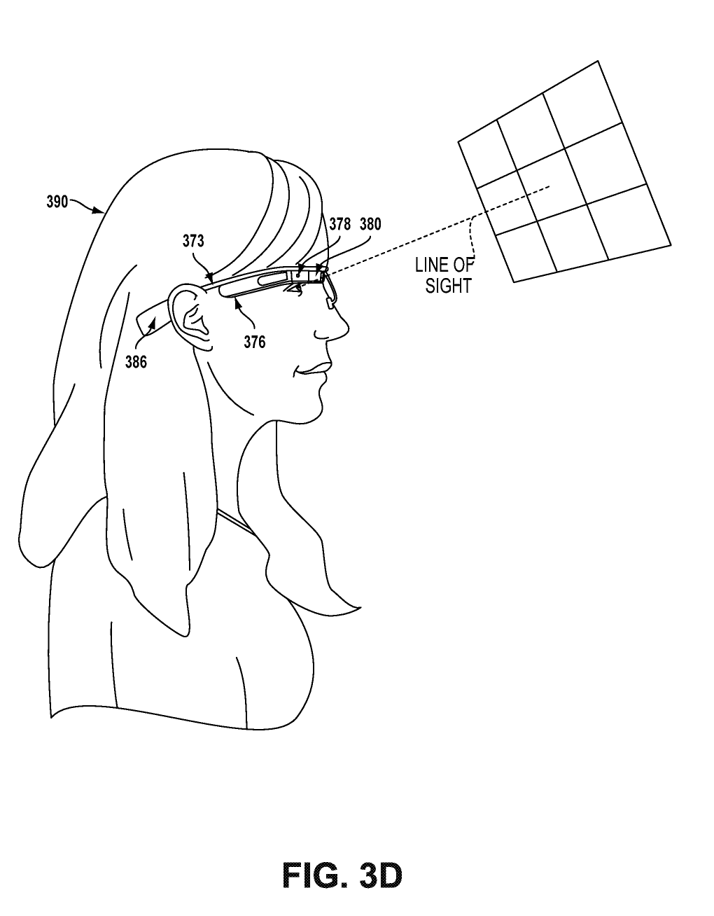

FIG. 3A illustrates a head-mountable device (HMD) according to an example embodiment, which takes the form of a monocular HMD 372. HMD 372 can include side-arms 373, a center frame support 374, and a bridge portion with nosepiece 375. In the example shown in FIG. 3A, the center frame support 374 connects the side-arms 373. HMD 372 does not include lens-frames containing lens elements; however, other embodiments could include lens-frames and lens elements. HMD 372 can additionally include a component housing 376, which can include an on-board computing system (not shown), an image capture device 378, a light source 385, and a button 379 for operating the image capture device 378 (and/or usable for other purposes). Component housing 376 can also include other electrical components and/or can be electrically connected to electrical components at other locations within or on the HMD.

HMD 372 also includes a speaker 386 for generating audio output. In one example, the speaker could be in the form of a bone conduction speaker, also referred to as a bone conduction transducer (BCT). Speaker 386 can be, for example, a vibration transducer or an electroacoustic transducer that produces sound in response to an electrical audio signal input. The frame of HMD 372 can be designed such that when a user wears HMD 372, the speaker 386 contacts the wearer. Alternatively, speaker 386 can be embedded within the frame of HMD 372 and positioned such that, when HMD 372 is worn, speaker 386 vibrates a portion of the frame that contacts the wearer. In either case, HMD 372 can be configured to send an audio signal to speaker 386, so that vibration of the speaker can be directly or indirectly transferred to the bone structure of the wearer. When the vibrations travel through the bone structure to the bones in the middle ear of the wearer, the wearer can interpret the vibrations provided by BCT 386 as sounds.

Various types of bone-conduction transducers (BCTs) can be implemented, depending upon the particular implementation. Generally, any component that is arranged to vibrate HMD 372 can be incorporated as a vibration transducer. Yet further it should be understood that HMD 372 can include a single speaker 386 or multiple speakers. In addition, the location(s) of speaker(s) on the WCD can vary, depending upon the implementation. For example, a speaker can be located proximate to a wearer's temple (as shown), behind the wearer's ear, proximate to the wearer's nose, and/or at any other location where the speaker 386 can vibrate the wearer's bone structure.

HMD 372 can include an optical system 380, which can be coupled to one of the side-arms 373 via the component housing 376. In an example embodiment, the optical system 380 can be made of glass and/or another transparent or translucent material, such that the wearer can see his or her environment through the optical system 380. Further, the component housing 376 can include a multi-pixel display and an imager (not shown) optically coupled to the optical system 380 and/or optical elements (not shown) to direct light between the multi-pixel display and the imager and the exposed aspects of the optical system 380. As such, optical system 380 can include further optical elements that direct light that is generated by the multi-pixel display towards the wearer's eye and that direct light reflected by the wearer's eye towards the imager when HMD 372 is being worn.

Optical features of the optical system 380 can be further configured such that, when the wearer has adjusted the direction and focus of their eye such that the light generated by the multi-pixel display is in-focus on the wearer's retina, light reflected by the retina is in-focus on the imager. That is, the optical system 380 can be configured to optically couple the multi-pixel display and the imager to the retina of the wearer of the HMD 372 such that the retina is at a focal surface that is conjugate to both a focal surface at the multi-pixel display and another focal surface at the imager. The disposition and configuration of the optical elements of the optical system 380 can be similar to the configuration of the proximal portion 230, the distal portion 230, and the light pipe 240 of the optical system 210 described in FIG. 2, or can be configured in another way.

HMD 372 can also include a light source 385. The light source 385 can be configured to produce light of a near-infrared wavelength capable of being transmitted through a temple of the wearer to illuminate the retina of the wearer. The light source 385 can be located in the component housing 376 such that when a user wears HMD 372 the light source 385 is able to illuminate the retina of the wearer through the temple of the wearer. The light source 385 can be located on HMD 372 as illustrated in FIG. 3A or located at another location on HMD 372 such that the light source 385 is able to illuminate the retina of the wearer of the HMD 372. The light source 385 could be configured to project light into the optical system 380 and the optical system 380 could be configured to direct the light produced by the light source 385 toward the eye of the wearer of the HMD 372. The light source could produce light of wavelengths other than a near-infrared wavelength capable of being transmitted through a temple of the wearer to illuminate the retina of the wearer.

The imager can include an array of photodetectors. For example, the imager could include an array of CMOS active pixel elements. In another example, the imager could include a CCD image sensor array. The imager can be configured to be sensitive to light of a wavelength corresponding to wavelength of the light produced by the light source 385. For example, the imager could include a filter that selectively passes light of wavelengths corresponding to wavelength of the light produced by the light source 385. Alternatively or additionally, the optical system 380 could include a wavelength-selective filter, reflector, or other element configured to prevent light of wavelengths other than the wavelength of the light produced by the light source 385 from reaching the imager. The imager could be configured to image the retina of the wearer using ambient light reflected by the retina of the wearer.

The multi-pixel display can be a system that generates a spatially-modulated pattern of light. For example, the multi-pixel display could include an organic light-emitting diode (OLED) array. In other examples, the multi-pixel display could include an array of selectively reflective or transmissive elements and a display light source. For example, the multi-pixel display could include a liquid crystal on silicon (LCoS) display panel or an array of digital micromirrors. The HMD 372 could further include a display light source (not shown) that could generate display light that the array of selectively reflective or transmissive elements could spatially modulate to generate the spatially modulated pattern of light. The optical system 380 could be configured to facilitate such a relationship between the display light source and array of selectively reflective or transmissive elements.

In a further aspect, HMD 372 can include a sliding feature 384, which can be used to adjust the length of the side-arms 373. Thus, sliding feature 384 can be used to adjust the fit of HMD 372. Further, HMD 372 can include other features that allow a wearer to adjust the fit of the HMD, without departing from the scope of the invention.

FIGS. 3B to 3D are simplified illustrations of HMD 372 shown in FIG. 3A, being worn by a wearer 390. In these examples, the optical system 380 can be arranged such that when HMD 372 is worn, optical system 380 is positioned in front of or proximate to a user's eye when HMD 372 is worn by a user. For example, optical system 380 can be positioned below the center frame support and above the center of the wearer's eye, as shown in FIG. 3B. Further, in the illustrated configuration, optical system 380 can be offset from the center of the wearer's eye (e.g., so that the center of optical system 380 is positioned to the right and above of the center of the wearer's eye, from the wearer's perspective).

Configured as shown in FIGS. 3B to 3D, optical system 380 can be located in the periphery of the field of view of the wearer 390, when HMD 372 is worn. Thus, as shown by FIG. 3C, when the wearer 390 looks forward, the wearer 390 can see the optical system 380 with her peripheral vision. As a result, optical system 380 can be outside the central portion of the wearer's field of view when her eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the optical system 380 is located as shown, the wearer 390 can view images emitted from the optical system 380 by, e.g., looking up with her eyes only (possibly without moving her head). When viewing images from the optical system 380, the retina of the user can be imaged by the optical system 380. This is illustrated as shown in FIG. 3D, where the wearer has moved her eyes to look up and align her line of sight with the optical system 380. Alternatively, a wearer might use the optical system 380 by tilting her head down to align her eye with the optical system 380.

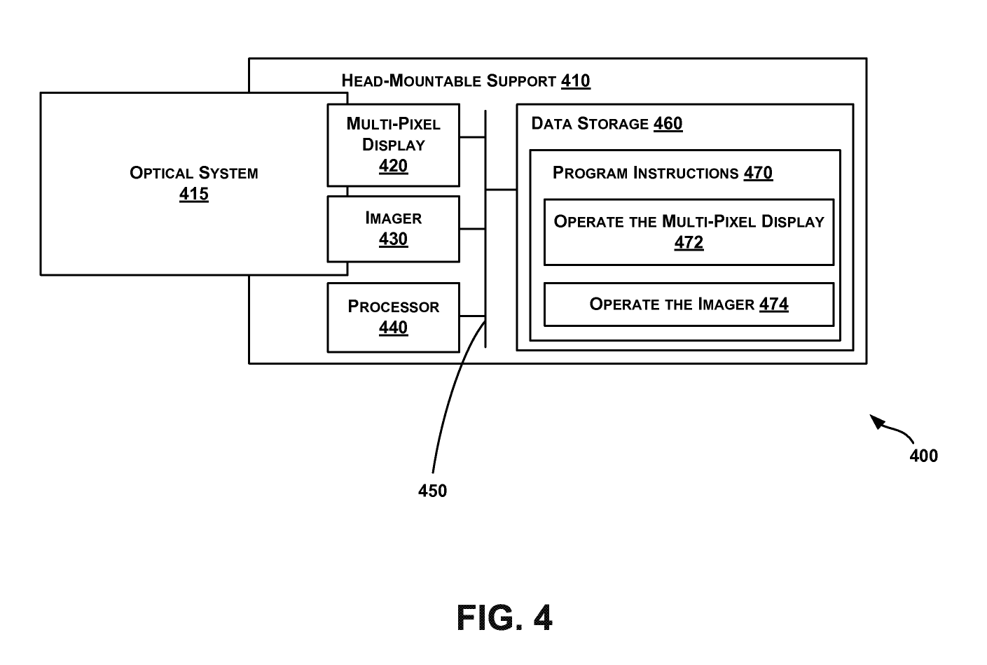

FIG. 4 is a functional block diagram of an HMD 400 that is configured to project a spatially-modulated pattern of light to a retina of a wearer of the device and to image the retina of the wearer of the device, according to an example embodiment. HMD 400 can be any type of device that can be mounted to the head of the wearer, project a spatially-modulated pattern of light to the retina of the wearer, and image the retina of the wearer. For example, HMD 400 can be any one of the HMDs described with reference to FIGS. 2 to 3.

HMD 400 can include a head-mountable support 410, an optical system 215, a multi-pixel display 420, an imager 430, a processor 440, a system bus 450, and data storage 460. The head-mountable support 410 can be any structure that can be mounted to the head of the wearer and support the other components of the HMD 400 (e.g., 415, 420, 430, 440, 450, 460) in an orientation in which the HMD 400 is able to project a spatially-modulated pattern of light to the retina of the wearer and image the retina of the wearer. The system bus 450 can be configured to facilitate communication between other components of the HMD 400 (e.g., between the processor 440 and the data storage 460) and/or to facilitate operation of components of the HMD 400 by the processor 440 (e.g., the multi-pixel display 420 and/or the imager 430).

The optical system 415 can be any configuration of optical elements operatively coupled to the multi-pixel display 420 and the imager 430 such that, when the wearer has adjusted the direction and focus of the wearer's eye such that the light generated by the multi-pixel display 420 is in-focus on the wearer's retina, light reflected by the retina is in-focus on the imager 430. That is, the optical system 415 can be configured to optically couple the multi-pixel display 420 and the imager 430 to the retina of the wearer of the HMD 400 such that the retina is at a focal surface that is conjugate to both a focal surface at the multi-pixel display 420 and another focal surface at the imager 430. The disposition and configuration of the optical elements of the optical system 415 can be similar to the configuration of the proximal portion 230, the distal portion 230, and the light pipe 240 of the optical system 210 described in FIG. 2, or can be configured in another way. In an example embodiment, the optical system 415 can be made of glass and/or another transparent or translucent material, such that the wearer can see their environment through the optical system 415.

The multi-pixel display 420 can be any system that generates a spatially-modulated pattern of light. For example, the multi-pixel display 420 could include an organic light-emitting diode (OLED) array. In other examples, the multi-pixel display 420 could include an array of selectively reflective or transmissive elements and a display light source. For example, the multi-pixel display 420 could include a liquid crystal on silicon (LCoS) display panel or an array of digital micromirrors. The HMD 400 could further include a display light source (not shown) that could generate display light that the array of selectively reflective or transmissive elements could spatially modulate to generate the spatially modulated pattern of light. The optical system 415 could be configured to facilitate such a relationship between the display light source and array of selectively reflective or transmissive elements.

The imager 430 can be any element capable of detecting light reflected by the retina of the user and generating an image of the reflected light. The imager 430 could include an array of photodetectors. In one example, the array of photodetectors could include CMOS active pixel elements. In another example, the imager 430 could include a CCD image sensor array. The imager 430 could be configured to be sensitive to light of a wavelength corresponding to a wavelength of light produced by an imaging light source (not shown) disposed in the HMD 400, for example, wavelengths in the ultraviolet, visible, or infrared portions of the electromagnetic spectrum. For example, the imager 430 could include a filter that selectively passes light of wavelengths corresponding to the wavelength of the light produced by the imaging light source and reflected by the retina of the wearer. Alternatively or additionally, the optical system 415 could include a wavelength-selective filter, reflector, or other element configured to prevent light of wavelengths other than the wavelength of the light produced by the imaging light source from reaching the imager 430. The imaging light source could include an LED, a laser, or some other type of light-producing element. The imaging light source could additionally include optics that could include elements configured to direct the light produced by the imaging light source toward the retina of the wearer. The imager 430 could be configured to image the retina of the wearer using ambient light reflected by the retina of the wearer.

The processor 440 is in communication with data storage 460. Data storage 460 is a non-transitory computer-readable medium that can include, without limitation, magnetic disks, optical disks, organic memory, and/or any other volatile (e.g. RAM) or non-volatile (e.g. ROM) storage system readable by the processor 440. Data storage 460 can include program instructions 470 that can be executed by the processor 440 to cause the HMD 400 to perform functions specified by the program instructions 470. For example, the program instructions 470 can cause the HMD 400 to perform any of the functions described herein. Data storage 460 can also include other information. For example, data storage 460 could contain parameter and configuration data necessary for the operation of the HMD 400 or for performance of the functions specified by the program instructions 470. In another example, data storage 460 could be used by the processor 440 to store data relating to the operation of the HMD 400. For example, data storage 460 could be used to store images of the retina of the wearer that could be generated by the imager 430 or could be used to store a record of the timing of use of the HMD 400 by the wearer.

Program instructions 470 could include instructions which could be executed by the processor 440 to operate the multi-pixel display 472. Operating the multi-pixel display 472 could include powering the multi-pixel display 420. Operating the multi-pixel display 472 could further include configuring the multi-pixel display 420 to produce one or more patterns of spatially-modulated light. Operating the multi-pixel display 472 could include transferring image data to the multi-pixel display 420 to define a pattern of spatially-modulated light to be produced by the multi-pixel display. Operating the multi-pixel display 472 could further include operating a display light source (not shown) disposed in the HMD 400 to produce light that the multi-pixel display could spatially modulate to produce a pattern of spatially-modulated light. The timing of changing the pattern of the spatially-patterned light produced by the multi-pixel display 420 could be periodic or could be variable according to an application.

Program instructions 470 could include instructions which could be executed by the processor to operate the imager 474. Operating the imager 474 could include powering the imager 430, configuring the imager 430 to generate an image or images, initiating generation of an image or images by the imager 430, and receiving data from the imager 430 corresponding to an image or images generated by the imager 430. Operating the imager 474 could include initiating generation of an image by the imager 430 during a time period when the multi-pixel display 420 is producing light. Operating the imager 474 could include initiating generation of an image by the imager 430 during a time period when an imaging light source (not shown) disposed in the HMD 400 is producing light. Operating the imager 474 could also include initiating generation of an image by the imager 430 during a time period when the imaging light source was not producing light. Operating the imager 474 could include initiating generation of images by the imager 430 at a plurality of points in time, according to an application.

Program instructions 470 could include other instructions. For example, program instructions could include instructions which could be executed by the processor 440 to determine one or more features of a retina based on one or more images of the retina. In an example, determining one or more features of a retina based on one or more images of the retina could include determining a pattern of retinal vasculature from an image of the retina. For example, if a the vasculature of the retina reflected less of an incident illuminating light than the rest of the retina, an image of the retina generated by the imager 430 could indicate the location of the vasculature. The location of the vasculature could be processed into a pattern of the retinal vasculature.

Determining one or more features of a retina based on one or more images of the retina could additionally or alternately include determining a diameter or diameters of the vasculature of the retina. Program instructions 470 could further include instructions which could be executed by the processor 440 to diagnose a disease or deformation of the retina or of the vasculature of the retina based on at least the determined pattern and/or diameters of the vasculature of the retina. For example, the determined pattern and/or diameters of the retinal vasculature could be used to determine whether a wearer of the HMD 400 was experiencing hypertensive retinopathy, diabetic retinopathy, one or more retinal macroaneurisms, or some other disorder of the retina or retinal vasculature.

In another example, determining one or more features of a retina based on one or more images of the retina could include determining a gaze direction of the retina. For example, a pattern of retinal vasculature could be determined as described above. From this pattern, a location of an optic disc of the wearer could be determined. A gaze direction could be determined based on the determined location of the optic disc and information on the relationship between the optic disc and the gaze direction for the wearer that could be stored in data storage 460.

Other methods of determining a gaze direction could be included in determining one or more features of a retina based on one or more images of the retina. In one example, the optic disc of the retina of the wearer could reflect substantially more of an incident illuminating light than other aspects of the retina of the wearer. An image of the retina generated by the imager 430 could indicate a location of the optic disc. A gaze direction could be determined based on the determined location of the optic disc and information on the relationship between the optic disc and the gaze direction for the wearer that could be stored in data storage 460.

Determining one or more features of a retina based on one or more images of the retina could include determining other features of the retina than those disclosed here. Determining one or more features of a retina based on one or more images of the retina 476 could include determining multiple features of the retina. The features of the retina could be determined using the methods disclosed herein or other methods familiar to one skilled in the art.

Program instructions 470 could include further instructions. For example, program instructions 470 could include instructions which could be executed by the processor 440 to compare a determined pattern of the vasculature of the retina to a stored pattern. For example, the pattern of the retinal vasculature of the wearer of the HMD 400 could be determined and compared to a stored pattern that could be stored in data storage 460. If the comparison finds that the determined pattern of the wearer is similar enough to the stored pattern, the operation of the HMD 400 could be altered according to information that could be stored in data storage 460 that is associated with the stored pattern. For example, functions specified by the information associated with the stored pattern could be enabled. In another example, the HMD 400 could identify the wearer of the HMD 400 to other systems in communication with the HMD 400 based on the information associated with the stored pattern. Other functions could be performed based on the comparison of a determined pattern of the retinal vasculature of the wearer of the HMD 400 to a stored pattern.

In another example, program instructions 470 could include instructions which could be executed by the processor 440 to operate the HMD 400 based on one or more features of a retina determined from one or more images of the retina. For example, the HMD 400 could use one or more images of the retina to determine a gaze direction. The gaze direction could be used to determine an object in the environment of the wearer that is the target of the wearer's gaze. In another example, the HMD 400 could present a virtual image to the wearer of the HMD 400 using the multi-pixel display 420. The gaze direction could be used to determine an object in the virtual image that the wearer was looking at and the operation of the HMD 400 could be altered based on the identity of the determined object. For example, the HMD 400 could perform a function associated with the determined object. In another example, the HMD 400 could operate the multi-pixel display 420 to alter the virtual image based on the identity of the determined object. For example, the HMD 400 could shift the virtual image produced by the multi-pixel display 420 so that the determined object was moved toward the center of a field of view of the virtual image. In another example, the determined object could increase or decrease in size. Other methods of operating the HMD 400 based on the determined gaze direction are possible. Further, other determined features of the retina could be used to operate the HMD 400.

The HMD 400 could include components in addition to those described here. For example, the HMD 400 could include a user interface, a communications interface, a battery, a bone conduction transducer (BCT) or other components according to an application. Further, the program instructions 470 could include additional instructions that, when executed by the processor 430, could enable the HMD 400 to operate the additional components or could enable other functions in addition to those described here.

In some examples, the HMD 400 could image the retina of the wearer and store the image, without necessarily determining a feature of the retina. Alternatively, the stored image could be analyzed at a later time to determine one or more features of the retina. In some examples, the HMD 400 could image the retina of the wearer and communicate the image to another device or system. The HMD 400 could include a communication interface configured to enable communication with a server; images of the retina generated by the HMD 400 could be communicated to the server using the communication interface. The server could then determine a feature of the retina, using the sent images, and send information to the HMD based on the determined features.

Example head mounted devices (HMDs) described above have been described as imaging a retina by detecting light reflected by the retina from an illumination source (e.g., a light source disposed on the HMD, a multi-pixel display, or an ambient light source). However, HMDs which image a retina using multiple light sources are anticipated. For example, an HMD could include a plurality of light sources each configured to produce light of a different wavelength. Additionally or alternatively, an HMD could include a plurality of sensors each sensitive to light of a different wavelength or range of wavelengths. In another example, an HMD could include a light source configured to produce light of an adjustable wavelength. If the multi-pixel display is configured to produce colored spatially-patterned light, the multi-pixel display could illuminate the retina of the wearer during different time periods using different colors of light. Different images of the retina generated by imaging the light reflected by the retina from different sources of illumination could be used together to determine one or more features of the retina.

### III. Example Methods

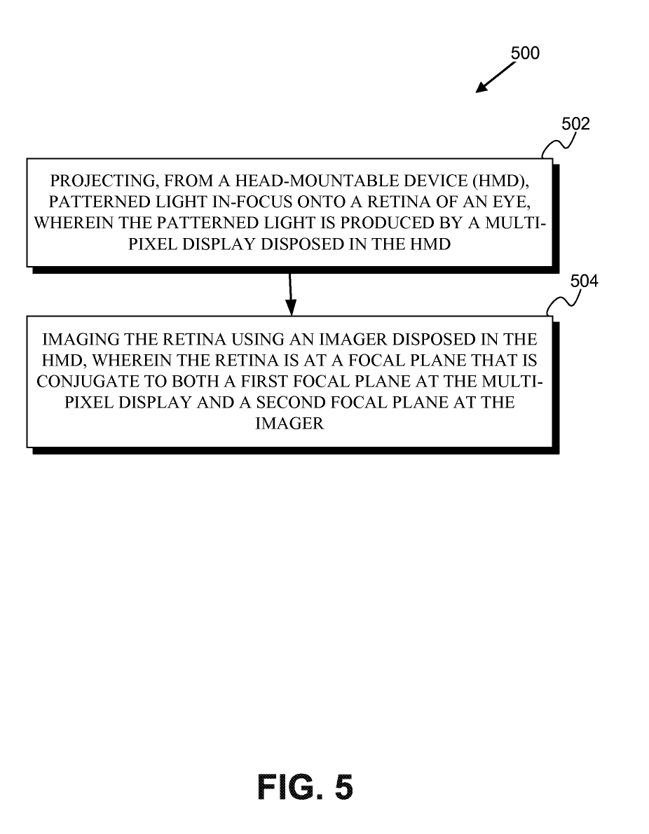

FIG. 5 is a flowchart of an example method 500 for imaging a retina of an eye and projecting patterned light in-focus on said retina, using a head-mountable device (HMD). In this example, the HMD has been mounted on a wearer and adjusted so that the HMD is optically coupled to the wearer's eye. The method 500 includes projecting, from the HMD, patterned light in-focus onto the retina of the eye, wherein the patterned light is produced by a multi-pixel display disposed in the HMD (502). Projecting patterned light in-focus onto the retina (502) could include configuring the multi-pixel display to produce one or more patterns of spatially-modulated light. Projecting patterned light in-focus onto the retina (502) could include operating a display light source disposed in the HMD to produce light that the multi-pixel display could spatially modulate to produce a pattern of spatially-modulated light. The timing of changing the pattern of the spatially-patterned light produced by the multi-pixel display could be periodic or could be variable according to an application.

The method 500 also includes imaging the retina using an imager disposed in the HMD, wherein the retina is at a focal plane that is conjugate to both a first focal plane at the multi-pixel display and a second focal plane at the imager (504). Imaging the retina (504) could include initiating generation of an image or images by the imager. Imaging the retina (504) could include initiating generation of an image by the imager during a time period when the multi-pixel display is producing light. Imaging the retina (504) could include initiating generation of an image by the imager during a time period when an imaging light source (not shown) disposed in the HMD is producing light. Imaging the retina (504) could also include initiating generation of an image by the imager during a time period when the imaging light source was not producing light. Imaging the retina (504) could include initiating generation of images by the imager at a plurality of points in time, according to an application.

The method 500 could include other steps. For example, the method could include determining one or more features of the retina based on one or more images of the retina using the imager disposed in the HMD. In an example, determining one or more features of the retina based on one or more images of the retina could include determining a pattern of retinal vasculature from an image of the retina. For example, if a the vasculature of the retina reflected less of an incident illuminating light than the rest of the retina, an image of the retina generated by the imager could indicate the location of the vasculature. The location of the vasculature could be processed into a pattern of the retinal vasculature.

Determining one or more features of a retina based on one or more images of the retina using the imager disposed in the HMD could additionally or alternatively include determining a diameter or diameters of the vasculature of the retina. The method 500 could further include diagnosing a disease or deformation of the retina or of the vasculature of the retina based on at least the determined pattern and/or diameters of the vasculature of the retina. For example, the determined pattern and/or diameters of the retinal vasculature could be used to determine whether a wearer of the HMD was experiencing hypertensive retinopathy, diabetic retinopathy, one or more retinal macroaneurisms, or some other disorder of the retina or retinal vasculature.

In another example, determining one or more features of a retina based on one or more images of the retina using the imager disposed in the HMD could include determining a gaze direction of the retina. For example, a pattern of retinal vasculature could be determined as described above. From this pattern, a location of an optic disc could be determined. A gaze direction could be determined based on the determined location of the optic disc and information on the relationship between the optic disc and the gaze direction.

Other methods of determining a gaze direction could be included in determining one or more features of a retina based on one or more images of the retina using the imager disposed in the HMD. In one example, the optic disc of the retina could reflect substantially more of an incident illuminating light than other aspects of the retina. An image of the retina generated by the imager could indicate a location of the optic disc. A gaze direction could be determined based on the determined location of the optic disc and information on the relationship between the optic disc and the gaze direction.

Determining one or more features of a retina based on one or more images of the retina using the imager disposed in the HMD could include determining other features of the retina than those disclosed here. Determining one or more features of a retina based on one or more images of the retina using the imager disposed in the HMD could include determining multiple features of the retina. The features of the retina could be determined using the methods disclosed herein or other methods familiar to one skilled in the art.

The method 500 could include comparing a determined pattern of the vasculature of the retina to a stored pattern. For example, the pattern of the retinal vasculature could be determined and compared to a stored pattern that could be stored in the HMD. If the comparison finds that the determined pattern is similar enough to the stored pattern, the operation of the HMD could be altered according to information that could be stored in the HMD that is associated with the stored pattern. For example, functions of the HMD specified by the information associated with the stored pattern could be enabled. In another example, the HMD could identify the retina to other systems in communication with the HMD based on the information associated with the stored pattern. Other functions could be performed based on the comparison of a determined pattern of the retinal vasculature to a stored pattern.

In another example, the method 500 could include operating the HMD based on one or more features of a retina determined from one or more images of the retina using the imager disposed in the HMD. For example, the HMD could use one or more images of the retina to determine a gaze direction. The gaze direction could be used to determine an object in the environment of the HMD that is coincident with the gaze direction. In another example, the HMD could present a virtual image to the retina using the multi-pixel display. The gaze direction could be used to determine an object in the virtual image that was coincident with the gaze direction and the operation of the HMD could be altered based on the identity of the determined object. For example, the HMD could perform a function associated with the determined object. In another example, the HMD could operate the multi-pixel display to alter the virtual image based on the identity of the determined object. For example, the HMD could shift the virtual image produced by the multi-pixel display so that the determined object was moved toward the center of a field of view of the virtual image. In another example, the determined object could increase or decrease in size. Other methods of operating the HMD based on the determined gaze direction are possible. Further, other determined features of the retina could be used to operate the HMD.

The method 500 could include steps in addition to those described here. For example, the method 500 could include imaging the retina and storing the image, without necessarily determining a feature of the retina. Alternatively, the method 500 could include storing the image and analyzing it at a later time to determine one or more features of the retina. In some examples, the method 500 could include imaging the retina and communicating the image to another device or system. The method 500 could include using the other device or system to determine a feature of the retina, based on the sent images, and using the other device or system to send information to the HMD based on the features determined by the other device or system.

### CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Further, where example embodiments involve information related to a person or a device of a person, some embodiments may include privacy controls. Such privacy controls may include, at least, anonymization of device identifiers, transparency and user controls, including functionality that would enable users to modify or delete information relating to the user's use of a product.

In situations in where embodiments discussed herein collect personal information about users, or may make use of personal information, the users may be provided with an opportunity to control whether programs or features collect user information (e.g., information about a user's medical history, social network, social actions or activities, profession, a user's preferences, or a user's current location), or to control whether and/or how to receive content from a content server that may be more relevant to the user. In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a content server.

1. A device comprising:
a head-mountable support;
a multi-pixel display supported by the head-mountable support, wherein the display is configured to generate a light pattern;
an image capture device supported by the head-mountable support, wherein the image capture device is configured to capture still images and/or video images; and
an optical system supported by the head-mountable support, wherein the optical system comprises an image former, a proximal beam splitter, and a distal beam splitter, wherein the image former is configured to (i) receive light from the multi-pixel display via the distal beam splitter and proximal beam splitter, (ii) focus the light received from the multi-pixel display onto a retina in an eye via a common optical path, the common optical path comprising the proximal beam splitter, (iii) receive via the common optical path light reflected by the retina, and (iv) focus the received light reflected by the retina onto the image capture device via the proximal beam splitter and distal beam splitter, such that the retina is at a focal plane that is conjugate to both a first focal plane at the multi-pixel display and a second focal plane at the image capture device.

2. The device of claim 1, wherein the image capture device comprises an array of photodetector elements.

3. The device of claim 1, further comprising:
a light source supported by the head-mountable support, wherein the light source is configured to illuminate the retina.

4. The device of claim 3, wherein the illumination source is configured to emit infrared light.

5. The device of claim 4, wherein the infrared light has wavelengths between 700 nm and 900 nm.

6. The device of claim 3, wherein the light source is configured to illuminate the retina through a temple of the wearer of the device.

7. The device of claim 3, wherein the light source is configured to illuminate the retina through the optical system.

8. The device of claim 1, wherein the light pattern generated by the multi-pixel display illuminates the retina, wherein the image capture device is configured to capture images of the retina using the light of the light pattern generated by the multi-pixel display that is reflected by the retina.

9. The device of claim 1, further comprising:
a display light source, wherein the display light source is configured to emit visible light, and wherein the multi-pixel display is configured to generate the light pattern by spatially modulating the visible light from the display light source.

10. The device of claim 1, wherein the multi-pixel display is an emissive display.

11. (canceled)

12. (canceled)

13. The device of claim 1, wherein the image former comprises a concave mirror.

14. The device of claim 1, further comprising:
a processor; and
data storage, wherein the data storage contains instructions that can be executed by the processor to perform functions, wherein the functions comprise: (i) operating the multi-pixel display to generate one or more light patterns and (ii) operating the image capture device to produce one or more images of the retina.

15. The device of claim 14, wherein the functions further comprise:
determining one or more features of the retina based on the one or more images of the retina.

16. The device of claim 15, wherein determining one or more features of the retina based on the one or more images of the retina comprises determining a gaze direction.

17. The device of claim 15, wherein determining one or more features of the retina based on the one or more images of the retina comprises determining a pattern of a vasculature of the retina.

18. The device of claim 17, wherein the functions further comprise:
comparing the determined pattern of the vasculature of the retina with a stored pattern.

19. The device of claim 17, wherein the functions further comprise:
detecting a disease or deformation of the vasculature of the retina using the determined pattern of the vasculature of the retina.

20. The device of claim 15, wherein the functions further comprise:
operating the device based on the determined one or more features of the retina.

21. A method comprising:
focusing, by an image former in a head-mountable device (HMD), patterned light onto a retina of an eye via a proximal beam splitter, wherein the patterned light is produced by a multi-pixel display disposed in the HMD and is received by the image former via the proximal beam splitter and a distal beam splitter;
receiving at the image former, via the proximal beam splitter, light reflected by the retina;
focusing, by the image former, the received light reflected by the retina onto an image capture device in the HMD via the proximal beam splitter and distal beam splitter, such that the retina is at a focal plane that is conjugate to both a first focal plane at the multi-pixel display and a second focal plane at the image capture device; and
capturing one or more images of the retina using the image capture device.

22. The method of claim 21, further comprising:
illuminating the retina using light produced by a light source disposed in the HMD, wherein capturing one or more images of the retina comprises the image capture device receiving light produced by the light source disposed in the HMD that is reflected by the retina.

23. The method of claim 22, wherein the light produced by the light source disposed in the HMD has a wavelength between 700 nm and 900 nm.

24. The method of claim 22, wherein the light source disposed in the HMD emits visible light and the multi-pixel display produces the patterned light by spatially modulating the visible light emitted by the light source.

25. The method of claim 21, further comprising:
determining one or more features of the retina based on the one or more images of the retina obtained using the image capture device disposed in the HMD.

26. The method of claim 25, wherein determining one or more features of the retina based on the one or more images of the retina comprises determining a gaze direction.

27. The method of claim 25, wherein determining one or more features of the retina based on the one or more images of the retina comprises determining a pattern of a vasculature of the retina.

28. The method of claim 27, further comprising:
comparing the determined pattern of the retinal vasculature with a stored pattern.

29. The method of claim 27, further comprising:
detecting a disease or deformation of the vasculature of the retina using the determined pattern of the vasculature of the retina.

30. The method of claim 25, further comprising:
operating the HMD based on the determined one or more features of the retina.
